(19) United States
(12) Patent Application Publication
(10) Pub. No.: US 2024/0225019 A1
(43) Pub. Date: Jul. 11, 2024

(54) DISSOLVABLE LIVESTOCK PROCESSING DEVICES AND METHODS OF USING SUCH DEVICES

(71) Applicant: Cargill, Incorporated, Wayzata, MN (US)

(72) Inventors: Tim Walter Abraham, Minnetonka, MN (US); Tyson Brown, Godley, TX (US); Tristan Lipkie, Maple Grove, MN (US)

(73) Assignee: Cargill, Incorporated, Wayzata, MN (US)

(21) Appl. No.: 18/559,725

(22) PCT Filed: May 25, 2022
(86) PCT No.: PCT/US2022/030884

§ 371 Date: Nov. 8, 2023

Related U.S. Application Data
(60) Provisional application No. 63/193,269, filed on May 26, 2021.

(51) Int. Cl. A22B 5/14

(52) U.S. Cl. CPC A22B 5/14

(57) ABSTRACT

Disclosed herein are livestock processing devices that can be dissolved in water or aqueous media during harvesting of livestock, such that products harvested from the livestock are free of particulate matter. In an aspect, the devices are made from a polyvinyl alcohol. In an aspect, the device is a weasand clip.

### CROSS-REFERENCE TO RELATED APPLICATIONS

This application claims the benefit of U.S. Provisional Patent Application No. 63/193,269, filed 26 May 2021, which is hereby incorporated by reference in its entirety.

### BACKGROUND

Weasand clips are devices used in processing cattle or other animal carcasses that seal the animal's esophagus (i.e., weasand) to prevent the gut contents from leaking out and contaminating products harvested from the animal. Weasand clips must eventually be removed during processing to avoid introducing foreign objects into byproduct recovery process. Some weasand clips are made of metal, or at least contain a significant amount of metal, and therefore can be identified by x-ray or removed during processing via a magnet. However, not all metal-containing weasand clips are successfully removed during processing. Further, metal-containing weasand clips may also be prone to degradation, and in some cases smaller metal fragments that are very difficult to remove via a magnet can break off the weasand clip and contaminate products.

### SUMMARY

Described herein are livestock processing devices, such as weasand clips, that can be dissolved during processing after they are used for the intended purpose. The devices can be used to mitigate or eliminate the contamination of products produced from livestock processing, including byproducts produced from rendering. In an aspect, the devices are made from a composition comprising polyvinyl alcohol that can be dissolved in water or aqueous media at a temperature typically associated with the rendering process.

In an aspect, the device is a device for livestock processing, comprising: polyvinyl alcohol (PVA), wherein the PVA dissolves in water or aqueous media at a temperature of 20 to 130° C. in 45 minutes or less; and wherein the device has a tensile strength suitable for use as a weasand clip. In an aspect, the device is a device for livestock processing consisting of or consisting essentially of: polyvinyl alcohol (PVA), wherein the PVA dissolves in water or aqueous media at a temperature of 20 to 130° C. in 45 minutes or less; and wherein the device has a tensile strength suitable for use as a weasand clip. In an aspect, the PVA is a PVA copolymer of PVA and one or more second polymers.

Described herein are also methods for livestock processing. In an aspect, the method is a method of livestock processing comprising: providing a weasand clip in accordance with the livestock processing devices comprising, consisting of, or essentially consisting of PVA described herein; slaughtering the animal to produce a carcass, wherein the weasand clip prevents or substantially prevents contamination of the carcass from the livestock animal's gut contents; and dissolving the weasand clip, wherein a food product produced from the carcass is free of or substantially free of particulate matter derived from the weasand clip.

### BRIEF DESCRIPTION OF THE FIGURES

The drawings illustrate generally, by way of example, but not by way of limitation, various embodiments discussed in the present document.

FIG. 1, comprising FIGS. 1A and 1B, is a set of photo images showing different views of an exemplary commercially available weasand clip (Adept Limited).

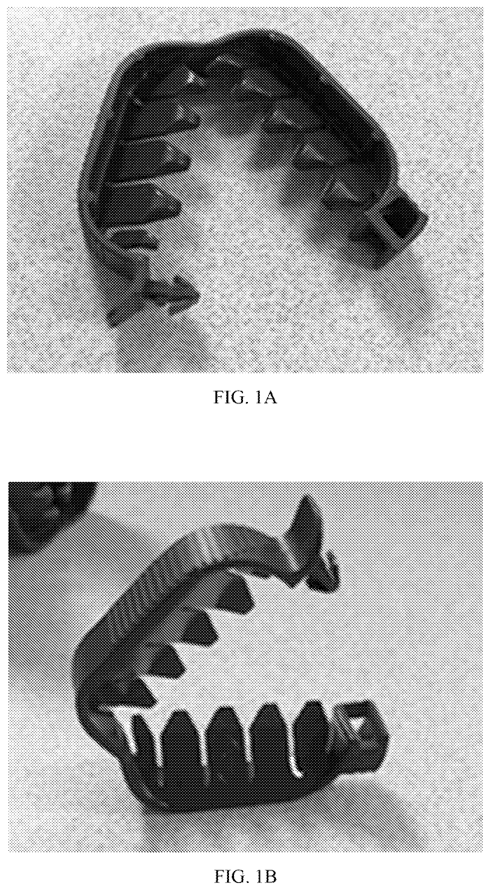

### DETAILED DESCRIPTION

Described herein are dissolvable livestock processing devices and methods of processing livestock using such devices. In an aspect, the methods described herein relate to preventing contamination of products produced from a slaughtered animal. The devices comprise a polymer composition that is suitable for use in feed applications. The polymer composition dissolves and/or degrades when exposed to water or aqueous media and elevated temperature, such that devices made from the composition can be removed from a livestock processing method in a manner that reduces or eliminates the risk of particulate contamination in the final product. In an aspect, any degradants or reactants produced from dissolving the polymer composition in water or aqueous media are also separately suitable for use in feed applications.

In an aspect, the polymer composition dissolves in conditions associated with a rendering step in livestock processing. In an aspect, a device made from the polymer composition completely dissolves within 45 minutes when heated in water at 127° C. Accordingly, the risk of particulate contamination from the device can be eliminated in a livestock processing method by dissolving the device in an aqueous process stream after the device has been used for its primary purpose.

In an aspect, the polymer composition comprises polyvinyl alcohol (PVA; polyvinyl alcohol may also be referred to as PVOH herein). In an aspect, the polymer composition comprises a partially hydrolyzed Polyvinyl acetate (PVAc) composition.

### Livestock Processing Devices

The devices described herein can be completely dissolved in water or aqueous media in conditions associated with byproduct rendering.

In an aspect, the devices can be completely dissolved in water or aqueous media within 45 minutes or less at 127° C. In an aspect, the devices can be completely dissolved in water or aqueous media within 45 minutes or less at 125-127° C. In an aspect, the devices can be completely dissolved in water within 45 minutes or less at 126-128° C. In an aspect, the devices can be completely dissolved in water or aqueous media within 30 minutes or less at 125-127° C. In an aspect, the devices can be completely dissolved in water or aqueous media within 15 minutes or less at 125-127° C. In an aspect, the devices can be completely dissolved in water or aqueous media within 45 minutes or less at 120-125° C. In an aspect, the devices can be completely dissolved in water or aqueous media in 10 minutes or less at 25° C. In an aspect, the devices can be completely dissolved in water or aqueous media in 6 minutes or less at 25° C. In an aspect, the devices can be completely dissolved in water or aqueous media in 3 minutes or less at 25° C. In an aspect, the devices can be completely dissolved in water or aqueous media in 10 minutes or less at 24-26° C. In an aspect, the devices can be completely dissolved in water or aqueous media in 10 minutes or less at 20-30° C. In an aspect, the devices can be completely dissolved in water or aqueous media in 10 minutes or less at 150° C. In an aspect, the devices can be completely dissolved in water or aqueous media in 1 minute or less at 150° C. In an aspect, the devices can be completely dissolved in water or aqueous media in 10 minutes or less at 20 to 130° C.

In an aspect, each of the dissolution conditions in the preceding paragraph refer to a device having a maximum thickness of approximately 1 cm in thickness, i.e., no portion of the device is significantly thicker than 1 cm. In an aspect, each of the dissolution conditions in the preceding paragraph refer to a device having a maximum thickness of approximately 4 mm, i.e., no portion of the device is significantly thicker than 4 mm. In an aspect, each of the dissolution conditions in the preceding paragraph refer to a device having a mass of 10 grams or less. In an aspect, each of the dissolution conditions in the preceding paragraph refer to a device having a mass of 1 to 10 grams. In an aspect, each of the dissolution conditions in the preceding paragraph refer to a device having a mass of about 5 grams. In an aspect, each of the dissolution conditions in the preceding paragraph refer to a device having a mass of 4.5 to 5.5 grams.

In an aspect, the polymer composition dissolves at a rate of 5 g/min or less; 4 g/min or less; 3 g/min or less; 2 g/min or less; 1 g/min or less; 0.9 g/min or less; 0.8 g/min or less; 0.7 g/min or less; 0.6 g/min or less; 0.5 g/min or less; 0.4 g/min or less; 0.3 g/min or less; 0.2 g/min or less; or 0.1 g/min or less. The rate of polymer composition dissolution can be measured using the same conditions (e.g., pellet type, buffer, temperature, and timing) as the Polymer Pellet Dissolution Test (defined below).

For the purposes of the claims, the dissolution conditions of the polymer composition used for the devices herein is evaluated as follows, referred to herein as the “Polymer Pellet Dissolution Test”: 1) pellets consisting of the polymer composition are obtained, wherein each pellet is substantially cylindrical in shape and has a diameter of 2 to 2.5 mm and a length of about 3 mm; 2) weigh about 0.2 g of the pellets and record exact weight; load pellets into a G30 30 mL glass vial with a micro stir bar and 20 mL of 0.1 M pH 5 acetate buffer; 3) seal the vial with airtight septum; load the vial into an Anton Paar Monowave 300 microwave reactor and set program to “heat as fast as possible” to 127° C. (heating time not more than 2 min), hold at 127° C. for 45 min while stirring at 900 rpm, then set program to “cool as fast as possible” to 70° C. using forced air; 4) removing vial and decanting or filtering aqueous solution from vial; and 5) recording visual observation of evidence of residual pellet material and weighing any residual pellet material after drying.

It is to be understood that the devices can be completely dissolved in aqueous media at the same time and temperature ranges as disclosed for dissolution in water provided in this disclosure. In an aspect, the aqueous media can be a brine solution or a buffer solution. In an aspect, the aqueous media is an acetate buffer solution. In an aspect, the aqueous media is a phosphate buffer solution. In an aspect, the aqueous media has a pH of 5, a pH of 4.8 to 5.2, a pH of 4.5 to 4.4, a pH of 5 to 7, or a pH of 6 to 7. In an aspect, the aqueous media comprises lactic acid and/or peracetic acid. In an aspect, the aqueous media comprises blood, viscera, bone, and/or lungs from a slaughtered animal. In an aspect, the aqueous media comprises, protein, peptides, lipids, and/or carbohydrates.

The terms “dissolvable,” “dissolved,” “completely dissolved.” and the like are used interchangeably herein with respect to the devices, and refer to the devices being dissolved or otherwise degraded or decomposed into a solution or a mixture that does not contain particulate matter in a form that would be problematic for livestock processing, i.e., the mixture does not contain particulate matter that would result in the rejection (also referred to as a “claim” or a “feed safety incident”), due to particulate matter, of a product resulting from livestock processing. In an aspect, “dissolvable,” “dissolved,” “completely dissolved,” and the like may refer to devices that contain processing aids or other materials, such as plasticizers and strength modifiers (e.g., clay), that may not completely dissolve during livestock processing (e.g., due to insolubility in water of clay), but that nonetheless are degraded, decomposed, and/or partially dissolved in a manner that yields a post-processing product that does not contain particulate matter that would result in the rejection (or a “claim” or a “feed safety incident”) of that product. In an aspect, such processing aids or other materials are considered inert or are otherwise suitable for feed products and feed processing. In an aspect, the post-processing product is free of particulate matter, i.e., no particulate matter can be detected. In an aspect, the post-processing product is free of particulate matter derived from the polymer composition, i.e., no particulate matter derived from the polymer composition can be detected. In an aspect, the post-processing product is substantially free of particulate matter, but any particulate matter detected would not result in a feed safety claim or rejection.

In an aspect, the devices are made from materials suitable for feed processing or contact with feed products. In an aspect, the devices are made from materials that dissolve and/or degrade into materials that are also suitable for feed processing or contact with feed products.

Although the devices described herein are readily dissolvable in water or aqueous media at relatively mild conditions, the devices must also have the structural integrity needed for the targeted application, and must maintain that structural integrity prior to the rendering processing step in which the device is dissolved. Accordingly, the weasand clip described herein must be suitable for sealing the esophagus of the carcass and for preventing the gut contents from contaminating any food or feed products being produced from the carcass. Further, the weasand clip must be of a size and shape that is suitable for dissolution within the desired processing time. Suitable designs for weasand clips that can be made from the polymer composition described herein are provided in U.S. Pat. No. 6,190,249, issued Feb. 20, 2001, and U.S. Pat. No. 8,540,741, issued Sep. 24, 2013, each of which are incorporated herein by reference in their entirety.

In an aspect, the device has a tensile strength of at least at least 1.0 MPa (Megapascal); at least 1.5 MPa; at least 2 MPa; at least 3 MPa; at least 4 MPa; at least 5 MPa; at least 6 MPa; at least 7 MPa; at least 8 MPa; at least 9 MPa; at least 10 MPa; at least 12 MPa; at least 15 MPa; at least 20 MPa; at least 25 MPa at least 30 MPa; at least 35 MPa; or at least 40 MPa.

In an aspect, the device has a glass transition temperature (Tg) of greater than or equal to 35° C., 40° C., 45° C., 50° C., 55° C., 60° C., 65° C., 70° C., 75° C., 80° C., or 85° C.

In an aspect, the device is a weasand clip. In an aspect, the device is a weasand plug. In an aspect, the device is any device suitable for sealing or substantially sealing the weasand or throat, or any other orifice or part of a livestock animal. However, the device can be other types of devices useful for livestock processing, for example, but not limited to: fasteners, such as tie wraps and plugs, and identification tags. In an aspect, the device is an identification tag suitable for being embedded or partially embedded in the livestock animal, for example but not limited to tags suitable for use in the LASER 3 tagging system available from BUNZL.

### Polymer Composition

The devices described herein may comprise PVA. PVA is generally produced by hydrolysis of polyvinyl acetate (PVAc), and can be produced having various degrees of hydrolysis. PVAc, i.e., fully acetylated PVA, is insoluble in water. The solubility of PVA in water generally increases with the degree of hydrolysis. As the acetate group content decreases with a corresponding increase of hydroxyl group content, the solubility of PVA increases. However, when the degree of hydrolysis approaches 100%, or is 100%, the solubility begins to decrease due to effects from intramolecular hydrogen bonding.

However, while the polymer composition for the devices described herein must be readily dissolvable in water at a relatively low temperature, the devices must also maintain the structural integrity needed for the targeted application. In some cases, the devices may be exposed to water or moisture during livestock processing prior to the desired point of dissolution. Accordingly, in an aspect, the PVA may be partially hydrolyzed such that a device made from the PVA has the desired balance between dissolution rate and structural integrity.

In an aspect, the polymer composition comprises PVA having a degree of hydrolysis of 0.01 to 99.99 mol %; 0.1 to 99.9 mol %; 0.1 to 99 mol %; 1 to 99 mol %; 0.1 to 98 mol %; 1 to 98 mol %; 0.1 to 97 mol %; 1 to 97 mol %; 0.1 to 96 mol %; 1 to 96 mol %; 0.1 to 95 mol %; 1 to 95 mol %; 1 to 90 mol %; 1 to 85 mol %; 1 to 80 mol %; 50 to 100 mol %; 50 to 99 mol %; 50 to 97 mol %; 50 to 95 mol %; 50 to 90 mol %; 50 to 85 mol %; 50 to 80 mol %; 60 to 100 mol %; 60 to 95 mol %; 60 to 90 mol %; 60 to 85 mol %; 60 to 80 mol %; 70 to 99 mol %; 70 to 97 mol %; 70 to 95 mol %; 70 to 90 mol %; 70 to 85 mol %; 70 to 80 mol %; 75 to 100 mol %; 75 to 99 mol %; 75 to 95 mol %; 75 to 90 mol %; 75 to 85 mol %; 80 to 99 mol %; 80 to 95 mol %; 80 to 90 mol %. In an aspect, the polymer composition consists of PVA having a degree of hydrolysis of 0.01 to 99.99 mol %; 0.1 to 99.9 mol %; 0.1 to 99 mol %; 1 to 99 mol %; 0.1 to 98 mol %; 1 to 98 mol %; 0.1 to 97 mol %; 1 to 97 mol %; 0.1 to 96 mol %; 1 to 96 mol %; 0.1 to 95 mol %; 1 to 95 mol %; 1 to 90 mol %; 1 to 85 mol %; 1 to 80 mol %; 50 to 100 mol %; 50 to 99 mol %; 50 to 97 mol %; 50 to 95 mol %; 50 to 90 mol %; 50 to 85 mol %; 50 to 80 mol %; 60 to 100 mol %; 60 to 95 mol %; 60 to 90 mol %; 60 to 85 mol %; 60 to 80 mol %; 70 to 99 mol %; 70 to 97 mol %; 70 to 95 mol %; 70 to 90 mol %; 70 to 85 mol %; 70 to 80 mol %; 75 to 100 mol %; 75 to 99 mol %; 75 to 95 mol %; 75 to 90 mol %; 75 to 85 mol %; 80 to 99 mol %; 80 to 95 mol %; 80 to 90 mol %. In an aspect, the polymer composition consists essentially of PVA having a degree of hydrolysis of 0.01 to 99.99 mol %; 0.1 to 99.9 mol %; 0.1 to 99 mol %; 1 to 99 mol %; 0.1 to 98 mol %; 1 to 98 mol %; 0.1 to 97 mol %; 1 to 97 mol %; 0.1 to 96 mol %; 1 to 96 mol %; 0.1 to 95 mol %; 1 to 95 mol %; 1 to 90 mol %; 1 to 85 mol %; 1 to 80 mol %; 50 to 99 mol %; 50 to 97 mol %; 50 to 95 mol %; 50 to 90 mol %; 50 to 85 mol %; 50 to 80 mol %; 70 to 99 mol %; 70 to 97 mol %; 70 to 95 mol %; 70 to 90 mol %; 70 to 85 mol %; 70 to 80 mol %; 75 to 95 mol %; 75 to 90 mol %; 75 to 85 mol %; 80 to 99 mol %; 80 to 95 mol %; 80 to 90 mol %.

In an aspect, the polymer composition comprises PVA having a number average molecular weight (Mn) of 100 kDa or less; 90 kDa or less; 80 kDa or less; 70 kDa or less; 60 kDa or less; 50 kDa or less; 40 kDa or less; 30 kDa or less; 10 to 100 kDa; 20 to 80 kDa; 20 to 60 kDa; 30 to 60 kDa; 20 to 50 kDa; or 30 to 50 kDa. In an aspect, the polymer composition consists of PVA having a number average molecular weight (Mn) of 100 kDa or less; 90 kDa or less; 80 kDa or less; 70 kDa or less; 60 kDa or less; 50 kDa or less; 40 kDa or less; 30 kDa or less; 10 to 100 kDa; 20 to 80 kDa; 20 to 60 kDa; 30 to 60 kDa; 20 to 50 kDa; or 30 to 50 kDa.

In an aspect, the water-soluble polymer composition can be a copolymer of PVA and one or more second polymers. Accordingly, throughout this disclosure, the word “PVA” shall also be construed to include “copolymer(s) of PVA with one or more second polymers.” The copolymers can be prepared in at least two ways. One method is to prepare the PVA and one or more second polymer(s) independently of each other, and then blend the PVA and one or more second polymers in varying ratios using methods known to those skilled in the art, such as by extrusion. A second method is to copolymerize the monomer for making PVA and the monomer(s) for making the one or more second polymer(s) in a polymerization reaction at the same time.

The monomer(s) for making the second polymer(s), i.e., the “second polymer monomer(s)” may have carboxylate or sulfonate functionality or esters of those two functional groups. Similar to the manufacture of PVA, the esters may be partially or fully hydrolyzed after polymerization. Examples of polymers containing such carboxylate functional groups are polyacrylic acid, polymethacrylic acid, polycrotonic acid, polyitaconic acid, polymaleic acid, and polyfumaric acid. The corresponding monomers that can be copolymerized with PVA monomers are acrylic acid, methacrylic acid, crotonic acid, itaconic acid, maleic acid, and fumaric acid.

Sulfonic acid-containing second polymer monomers include vinyl sulfonic acid, allyl sulfonic acid, ethylene sulfonic acid, 2-acrylamido-1-methylpropanesulfonic acid, 2-acrylamido-2-methylpropanesulfonic acid, 2-methylacrylamido-2-methylpropanesulfonic acid, and 2-sulfoethyl acrylate.

Other suitable second polymers include but are not limited to polyethyleneimines, polyvinyl pyrrolidones, pullulans, guar gums, xanthan gum, carrageenans, starches, ethoxylated starches, hydroxyethylated starches, hydroxypropylated starches, carboxymethylated starches, polyalkylene oxides, polyacrylamides, celluloses, cellulose ethers, cellulose esters, cellulosic amides, polyamino acids, polyamides, gelatins, methyl celluloses, carboxymethylated celluloses, maltodextrins.

The molar ratios of the monomer(s) in the resulting copolymers can be any ratio, such as from 1:99 to 99:1, so as to provide the desired properties for use in the present application. In an aspect, the molar ratio is 1-20 mole % of the second polymer monomer(s) relative to PVA.

Plasticizers can be included in the composition comprising PVA to reduce the brittleness and improve flexibility of the weasand clip. Such plasticizers include, but are not limited to, water, glycerol, glycols, glycol ethers, natural oils, fatty acid esters, epoxidized natural oils, citric acid esters, esters of various organic monocarboxylic acids and polycarboxylic acids, sorbitol, sugar esters. Starch derivatives, and Cellulose derivatives.

The tensile strength can be improved by the use of additives, such as talc, silica, clays, starch, cellulose, keratin, chitin, chitosan, polylactic acid, polyhydroxyalkanoates, and inorganic compounds such as calcium carbonate.

The PVA compositions described herein are suitable for use in food applications and generally non-toxic at the levels expected when using these PVA compositions in livestock processing applications such as a rendering step, see e.g., Kawai and Hu, Biochemistry of microbial polyvinyl alcohol degradation, Appl. Microbiol. Biotechnol. 2009, 84(2):227-37, which is hereby incorporated by reference in its entirety.

Devices made from the PVA compositions described herein can be produced using polymer manufacturing techniques presently known in the art, for example but not limited to: extrusion, injection molding, and/or 3D printing.

### Methods of Livestock Processing

The devices described herein can be used to prevent contamination of a product produced from a slaughtered animal. In an aspect, the methods include dissolving the device during the rendering step of livestock processing. The devices and polymer compositions described herein can be used for the processing of livestock such as cattle, bison, pigs, sheep and poultry.

In an aspect, the method of livestock processing comprises: providing a device comprising the polymer composition (or consisting of the polymer composition, or consisting essentially of the polymer composition); using the device in connection with a livestock animal or carcass during a livestock processing step; and dissolving the device following completing of the livestock processing step, wherein a food product produced from the animal or carcass is free of particulate matter derived from the device.

In an aspect, the method of livestock processing comprises: providing a weasand clip comprising the polymer composition (or consisting of the polymer composition, or consisting essentially of the polymer composition); connecting or implanting the weasand clip to a livestock animal prior to slaughtering the animal; slaughtering the animal to produce a carcass, wherein the weasand clip prevents or substantially prevents contamination of the carcass from the livestock animal's gut contents; and dissolving the weasand clip, wherein a feed product produced from the carcass is free of particulate matter derived from the weasand clip.

### EXAMPLES

The invention is further described in detail by reference to the following experimental examples. These examples are provided for purposes of illustration only, and are not intended to be limiting unless otherwise specified. Thus, the invention should in no way be construed as being limited to the following examples, but rather should be construed to encompass any and all variations which become evident as a result of the teaching provided herein.

### Example 1: Evaluation of Polyvinyl Alcohol (PVA)

This example describes benchtop screening of PVA for use in dissolvable or degradable weasand clips.

PVA samples were obtained commercially from Kuraray America, Inc. in various grades. Each sample was obtained as cylindrical pellets of about 2 to 2.5 mm diameter and about 3 mm length (example mass and dimensions of cylindrical pellets are listed in Table 1). Table 2 shows how fast each PVA sample dissolved in water at 25° C. or 80° C. Note that the tests in Table 2 were performed and published by Kuraray Europe GmbH and were done with 200 micron thick films at the reported temperatures.

TABLE 1

| PVA grade | Mass (mg) | Avg. Length (mm) | Avg. Diameter (mm) |
|---|---|---|---|
| H 15 | 15-16 | 3.1 | 2.2 |
| C 600 | 15-20 | 2.9 | 2.4 |
| M 05 | 16-17 | 3.1 | 2.5 |
| C 17 | 11-13 | 3.0 | 2.1 |

TABLE 2

| | | | | Max. moisture |
|---|---|---|---|---|
| | | Glass | Peak | uptake (%) |
| | Solubility | Transition | melting | (avg. at 23° C. |
| PVA | (temp and time to | Temp., | temp., Tm | and 50% relative |
| grade | dissolve) | Tg(° C.) | (° C.) | humidity) |
| C 17 | 25° C./3-6 min | 60 | 170 | 4 |
| C 30 | 25° C./3-6 min | 40 | 175 | 7 |
| C 600 | 25° C./<3 min | 35 | 165 | 7 |
| C 130T | 25° C./3-6 min | 45 | 170 | 4 |
| C 500T | 25° C./<3 min | 40 | 165 | 5 |
| M 05 | 55° C./>6 min | 45 | 195 | 6 |
| H 15 | 80° C./>6 min | 40 | 215 | 5 |

Table 2 note:
Tg and Tm provided from 2^{nd} heating cycle of DSC measurement at a heating rate of 10 K/min.

Dissolution reactions were completed in an Anton Paar Monowave 300 microwave reactor. About 0.2 g of polymer pellets were weighed, exact mass was recorded, then pellets were loaded into a G30 30 mL glass vial with a micro stir bar, 20 mL of 0.1 M pH 5 acetate buffer in DI water were added, and the vial was sealed with an air tight septum. Reactor program was set to “heat as fast as possible” to 127° C. (taking about 1 minute), hold for 45 minutes while stirring at 900 rpm, then “cool as fast as possible” to 70° C. with forced air (taking about 7 minutes). Table 3 shows the reaction conditions for each sample.

TABLE 3
PVA reaction conditions

| | Reaction # | | | |
|---|---|---|---|---|
| | 1 | 2 | 3 | 4 |
| sample | Mowiflex LP | Poval H15 | Poval C17 | Mowiflex M05 |
| | C600 | polyvinyl | polyvinyl | polyvinyl |
| | polyvinyl | alcohol | alcohol | alcohol |
| | alcohol | (Kuraray) | (Kuraray) | (Kuraray) |
| | (Kuraray) | | | |
| time | 45 | 45 | 45 | 45 |
| (min) | | | | |
| temp ° C. | 127 | 127 | 127 | 127 |
| solvent | pH 5 0.1M | pH 5 0.1M | pH 5 0.1M | pH 5 0.1M |
| | acetate | acetate | acetate | acetate |
| solvent | 20 | 20 | 20 | 20 |
| mL | | | | |
| polymer | 0.2103 | 0.2107 | 0.1984 | 0.2079 |
| g | | | | |

C600 was completely dissolved after 45 minutes at 127° C. No pellets or evidence of residual polymer was apparent.

H15 showed minor dissolution—or melting—forming a smooth disc on the bottom of the vial. The aqueous solution also turned hazy likely from partially soluble/dispersed polymers.

C17 mostly dissolved, bit not completely. A thick slurry of polymer rich phase was apparent on the bottom of the vial, which hardened onto air bubbles when inverted and cooled. The pellets began to stick to each other in solution before the heating reaction.

M05 was completely dissolved after 45 minutes at 127° C. No pellets or evidence of residual polymer was apparent.

Conclusion: Polyvinyl alcohol dissolution after 45 min at 127° C. at pH 5 depended on the particular PVA product grade. Mowiflex LP C 600 and Mowiflex M05 polyvinyl alcohol products showed the most complete dissolution, and were confirmed to have both acetate and —OH groups.

### Example 2: Evaluation of Polylactic Acid (PLA)

This example describes benchtop screening of PLA for use in dissolvable or degradable weasand clips.

Polylactic acid (PLA) pellets were obtained from NatureWorks. Three product codes were tested: 2003D, 4060D, and 6302D.

Dissolution reactions were completed in an Anton Paar Monowave 300 microwave reactor. About 0.2 g polymer pellets were weighed, exact mass was recorded, then pellets were loaded into a G30 30 mL glass vial with a micro stir bar, 20 mL of 0.1 M pH 5 acetate buffer in DI water were added, and the vial was sealed with an air tight septum. Reactor program was set to “heat as fast as possible” to 127° C. (taking about 1 minute), hold for 45 minutes while stirring at 900 rpm, then “cool as fast as possible” to 70 C with forced air (taking about 7 minutes). After decanting off the solution, residual polymer pellets were collected in a pre-weighed aluminum tin, and the polymer pellets were dried for at least 2 hours or until mass was constant in an Unox MindMap combi oven set at 45° C. and maximum moisture removal and constant fan at low.

Results are shown in Table 4. All PLA samples remained undissolved. Recoveries of slightly greater than 100% were likely due to residual sodium acetate. Pellets of biopolymers 4060D and 6302D melted together into one aggregated mass, while biopolymer 2003D remained as individual pellets.

TABLE 4
PLA dissolution reactions

| sample | 4060D | 6302D | 2003D |
|---|---|---|---|
| time (min) | 45 | 45 | 45 |
| temp ° C. | 127 | 127 | 127 |
| solvent | pH 5 0.1M | pH 5 0.1M | pH 5 0.1M |
| | acetate | acetate | acetate |
| solvent (mL) | 20 | 20 | 20 |
| polymer initial | 0.2013 | 0.2062 | 0.2018 |
| (g) | | | |
| polymer final (g) | 0.2036 | 0.2052 | 0.2051 |
| % recovered | 101.1 | 99.5 | 101.6 |

Conclusion: Polylactic acid samples tested were not dissolved after 45 min at 127° C. at pH 5, demonstrating that not all polymers are structurally suitable for livestock processing devices also have the desired dissolution characteristics for such applications.

1. A device for livestock processing, comprising:
polyvinyl alcohol (PVA), wherein the PVA dissolves in water or aqueous media at a temperature of 20 to 130° C. in 45 minutes or less; and wherein the device has a tensile strength suitable for use as a weasand clip.

2. A device for livestock processing, consisting of or consisting essentially of:
polyvinyl alcohol (PVA), wherein the PVA dissolves in water or aqueous media at a temperature of 20 to 130° C. in 45 minutes or less; and wherein the device has a tensile strength suitable for use as a weasand clip.

3. The device of claim 1, wherein the PVA has a degree of hydrolysis of 50-100 mol %.

4. The device of claim 1, wherein the PVA dissolves in water or aqueous media at a temperature of 25° C. in 45 minutes or less.

5. The device of claim 1, wherein the PVA dissolves in water or aqueous media at a temperature of 127° C. in 45 minutes or less.

6. The device of claim 1, wherein the dissolution of the PVA is measured according to the Polymer Pellet Dissolution Test using a pellet consisting of the PVA.

7. The device of claim 1, wherein the PVA further comprises one or more plasticizers.

8. The device of claim 1, wherein the PVA further comprises one or more additives selected from the group consisting of: talc, silica, clays, starch, cellulose, keratin, chitin, chitosan, polylactic acid, polyhydroxyalkanoates, and calcium carbonate.

9. The device of claim 1, wherein the PVA has a tensile strength of at least 1 MPa.

10. The device of claim 1, wherein the PVA has a glass transition temperature of 35° C. or greater.

11. The device of claim 1, wherein the PVA dissolves at a rate of 5 g/min or less.

12. The device of claim 1, wherein the PVA has a number average molecular weight (Mn) of 100 kDa.

13. The device of claim 1, wherein the device is a weasand clip or a weasand plug.

14. A method of livestock processing comprising:
providing a weasand clip according to the device of claim 1;
slaughtering the animal to produce a carcass, wherein the weasand clip prevents or substantially prevents contamination of the carcass from the livestock animal's gut contents;
and dissolving the weasand clip, wherein a food product produced from the carcass is free of or substantially free of particulate matter derived from the weasand clip.

15. The method of claim 14, wherein the weasand clip is dissolved in a rendering step.

16. The method of claim 15, wherein the rendering step is performed at a temperature of 127° C. for a time of at least 45 min.

17. The method of claim 14, wherein the livestock animal is cattle.

18. The method of claim 14, wherein the PVA is a PVA copolymer of PVA and one or more second polymers.

19. The method of claim 18, wherein the one or more second polymers in the PVA copolymer is formed from one or more of the following monomers: acrylic acid, methacrylic acid, crotonic acid, itaconic acid, maleic acid, fumaric acid, vinyl sulfonic acid, allyl sulfonic acid, ethylene sulfonic acid, 2-acrylamido-1-methylpropanesulfonic acid, 2-acrylamido-2-methylpropanesulfonic acid, 2-methylacrylamido-2-methylpropanesulfonic acid, or 2-sulfoethyl acrylate.

20. The method of claim 18, wherein the PVA copolymer is a copolymer of PVA and one or more of: a polyethyleneimine, a polyvinyl pyrrolidone, a pullulan, a guar gum, a xanthan gum, a carrageenan, a starch, a ethoxylated starch, a hydroxyethylated starch, a hydroxypropylated starch, a carboxymethylated starch, a polyalkylene oxide, a polyacrylamide, a cellulose, a cellulose ether, a cellulose ester, a cellulosic amide, a polyamino acid, a polyamide, a gelatin, a methylcellulose, a carboxymethylated cellulose, or a maltodextrin.

21. The method of claim 18, wherein the molar percent ratio of the total amount of the second polymer(s) in the PVA copolymer is 1-20% of the second polymer(s) relative to PVA.
